(19) United States
(12) Patent Application Publication
(10) Pub. No.: US 2009/0230185 A1
(43) Pub. Date: Sep. 17, 2009

(54) CASH REGISTER SYSTEM AND METHOD OF OPERATING A CASH REGISTER SYSTEM

(75) Inventors: Dirk Leonard Benschop, Etten-Leur (NL); Henderik Reinout Benschop, Rozenburg (NL); Sander Ewout Sciarone, Fijnaart (NL)

Correspondence Address: WESTMAN CHAMPLIN & KELLY, P.A., SUITE 1400, 900 SECOND AVENUE SOUTH, MINNEAPOLIS, MN, 55402, US

(73) Assignee: Hollandse Exploitatie Maatschappij B.V., Etten-Leur (NL)

(21) Appl. No.: 12/046,031

(22) Filed: Mar. 11, 2008

(51) Int. Cl. G06K 5/00

(52) U.S. Cl. 235/380

(57) ABSTRACT

An aspect of the invention relates to a cash register system and a method of operating a cash register system. The cash register system comprises an age verification system. An image of a person is captured and transmitted to a remote age verification center. An authorization signal is subsequently received if from the image the person can be determined to have an age allowing purchase of the age-restricted item. A release signal is provided to the cash register system only if the authorization signal is received in order to allow payment of the age-restricted item.

### BACKGROUND

The discussion below is merely provided for general background information and is not intended to be used as an aid in determining the scope of the claimed subject matter.

Aspects of the invention relate to a cash register system and method of operating a cash register system. In particular, aspects of the invention relate to age verification in relation to the purchase of age-restricted items at such a cash register system.

Nowadays, items as tobacco and alcoholic beverages receive increased attention as to their free availability for the under-aged. Instances of selling age-restricted goods to under-age individuals also often result from careless employee verifications of a consumer's age before the consumer purchases age-restricted goods. Commonly, employees who are supposed to be verifying a consumer's age will not even ask for the consumer's identification, and in systems that prompt employees to enter the consumer's birth date, employees often enter a fictitious birth date. Such careless age verification may go unnoticed by a store manager or owner.

On the other hand, government authorities are increasingly willing to enforce fines and license suspension penalties on establishments that sell age-restricted goods to underage individuals. If authorities catch an employee selling age-restricted products to underage consumers, the manager or owner is often held responsible for the employee's actions and may even have their license to sell age-restricted goods revoked as a result of their employee's careless behaviour.

US 2002/087413 describes a vending machine including a video camera for transmitting an image of a buyer to a remotely located human operator, a document reader for transmitting an image of identification documents to the remotely located human in control of the vending machine, and a user interface which gives the appearance that the machine is autonomous even though the operator's approval is required prior to vending an age-restricted item. The machine also includes a payment acceptor and a dispensing apparatus.

The method of operating the prior art vending machine provides a considerable burden users of this machine.

There exists a need in the art to provide a cash register system, i.e. a payment system, for payment of age-restricted items.

### SUMMARY

This Summary and Abstract are provided to introduce some concepts in a simplified form that are further described below in the Detailed Description. This Summary and Abstract are not intended to identify key features or essential features of the claimed subject matter, nor are they intended to be used as an aid in determining the scope of the claimed subject matter. In addition, the description herein provided and the claimed subject matter should not be interpreted as being directed to addressing any of the short-comings discussed in the Background.

An aspect of the present invention is a cash register system comprising an age verification system configured for verifying the age of a person for purchasing an age-restricted item. The age verification system comprises an image capture devices such as but not limited to a video camera configured for capturing an image of the person. Also, a connecting device is provided for connecting to a remote age verification center and configured to transmit the image of said person to this age verification center. The connecting device may also receive an authorization signal from the age verification center if, from the image the person, the person can be determined to have an age allowing purchase of the age-restricted item. Also, a controller is provided that is configured for providing a release signal to a cash register system only in response to receiving the authorization signal in order to allow payment of the age-restricted item.

Another aspect of the present invention is a computer-implemented method of operating a cash register system for payment of an age-restricted item by a person. The cash register system comprises an age verification system. An image of a person is captured and transmitted to a remote age verification center. An authorization signal is subsequently received if, from the image, the person can be determined to have an age allowing purchase of the age-restricted item. A release signal is provided to the cash register system only if the authorization signal is received in order to allow payment of the age-restricted item.

The person image can be captured quickly and only requires the person under consideration to expose him- or herself to the video camera, i.e. the burden is very low. In the majority of cases, it can be verified from the person image whether the age of the person is such that purchase of the age-restricted item is allowed. The cash register is only released for payment of this item, if the authorization signal is received from the remote age verification center, i.e. the burden is also low for the cashiers since they have no involvement in the age verification process. Finally, the burden is also low for shop owners, since the age-restricted items do not need to be contained in a vending machine but can be made available in a traditional off-shelf manner in the shop. Moreover, the age-restricted items can be bought using self service cash registers without requiring involvement of personal while still providing an appropriate check as to the age of the person buying the item. Consequently, a system and method are provided that enable quick age verification in combination with appropriate but secure selling of age-restricted items.

The age verification comprises two separate process phases.

In a first phase, an image is captured of the person by an image capture device (e.g. video camera). This image is sent to an age verification center within a very short time interval, possibly seconds. This process phase involves only a low burden and is convenient for the person involved. If it can be determined that the age of the person is appropriate for purchasing the age-restricted item(s), the authorization signal is received and the release signal releases the cash register system to allow payment for the age-restricted item.

Only if the age cannot be determined accurately by using the video camera, a second process phase may be required. This second phase involves the reading of an identification document of the person whose age could not be verified in the first phase. The image of the identification document, obtained from the same or another image capture device, should comprise a picture of the legitimate holder of the document. This process phase is typically more time-consuming than the first process phase. The image of the identification document, or a sample thereof, is sent to the age verification center. Moreover, the person image is obtained again, either from a database (or other means of storage) or from a second image by the image capture device in order to verify if the person's image and document image are associated with the same person. If this is true and it can be determined that age of the person in question is appropriate for purchasing the age-restricted item, the authorization signal is received and the cash register is released to allow payment for the age-restricted item in accordance with the embodiments of claims 2 and 7.

The age verification can be initiated in accordance with the embodiments of claims 4, 5, 8 and 9. As an example, the age verification process is triggered by scanning a bar code of the age-restricted item or by user input of e.g. a cashier or the person under consideration. These embodiments provide the advantage that in particular the person image is only captured when required.

The applicant also proposes a system comprising a cash register system and an age verification center.

It should be appreciated that the video camera and the document reader may be a single device, possibly with different settings adapted to the image to be made. The document reader may also be a scanner or a similar device.

It should also be appreciated that the image of the identification document may preferably contain an image of the legitimate holder of the identification document. The image of the identification document may comprise a complete image of (one or more pages of) the identification document, a part of the identification document and/or information derived from the identification document.

The system and method according to aspects of the invention may also be used for controlling systems other than a cash register system, in particular systems for which age verification is desired. Examples of such other systems include a gambling machine or an entrance to an entertainment center, for example, a bar, casino or discotheque. In these systems, the outcome of the age verification process determines whether the person under consideration may play on the gambling machine or may enter the entertainment center.

### BRIEF DESCRIPTION OF THE DRAWINGS

In the drawings:

FIGS. 1 provides a schematic illustration of a system in accordance with an embodiment of the invention;

FIG. 2 provides a schematic illustration of a cash register system in accordance with an embodiment of the invention; and

FIG. 3 provides a flow chart of a method of operating the cash register system of FIG. 2 in accordance with an embodiment of the invention.

### DETAILED DESCRIPTION OF THE ILLUSTRATIVE EMBODIMENT

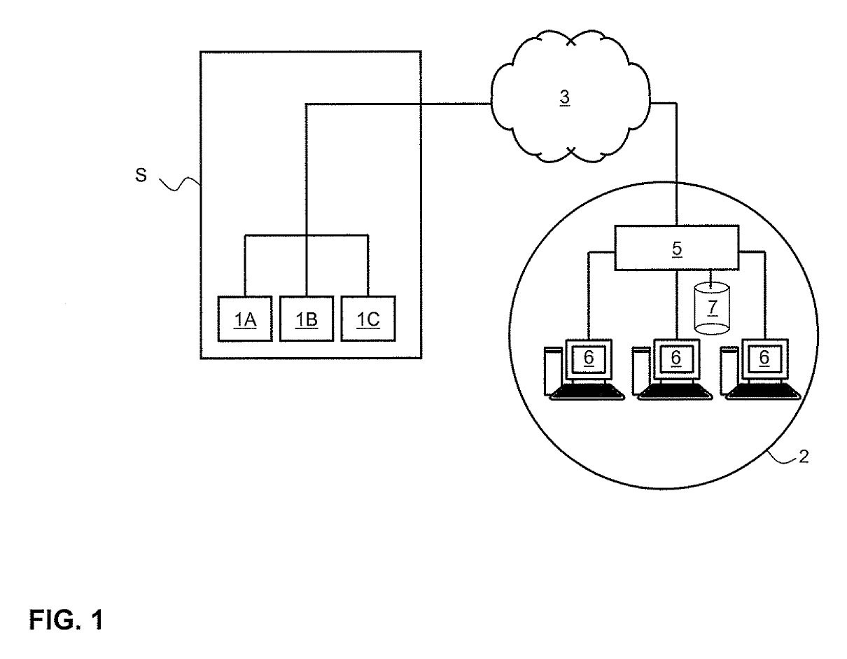

FIG. 1 shows a schematic illustration of a system comprising cash register systems 1A, 1B, 1C and an age verification center 2, hereinafter also referred to as verification center. The cash register systems 1A, 1B, 1C may be cash desks operated by a cashier or self service cash desks. The cash register systems 1A, 1B, 1C are connected to the remote age verification center 2 via a network 3. The network 3 may comprise a wired network and/or a wireless, local and/or wide area (e.g. Internet) network.

The cash register systems 1A-1C are located in a shop S. Shop S sells a plurality of goods (items), amongst which are age-restricted items, such as tobacco, alcoholic beverages, adult magazines, weapons etc. The cash desk systems 1A-1C are for payment of items of the shop S.

The verification center 2 comprises a controller 5 and one or more display units 6. The display units 6 are configured to display images received from the cash register systems 1A-1C to human beings in order to verify the age of potential purchasers of age-restricted items. The images include a person image of a potential purchaser and/or an image of (and/or a part of) an identification document.

Controller 5 distributes the received images amongst the display units 6. The controller 5 may execute a round robin distribution process for efficient distribution of the images. In case more images are received than can be handled by the display units 6, the controller 5 is configured to manage a waiting cue of images. The controller 5 is also configured for providing, in the first verification phase, a person image of a potential purchaser to a first display unit 6 and, for the subsequent second verification phase, the person image and the document image on a second display unit 6, different from the first display unit.

The verification center 2 also comprises a database 7. The database 7 may store the received images and other data received from the cash register systems 1A-1C for future use. The images can be retrieved from the database 7 when desired information from the database can be used for sales transaction information for shop owners and allows authorities to check the transactions regarding age-restricted items. Furthermore, the database information may be used for statistical analysis.

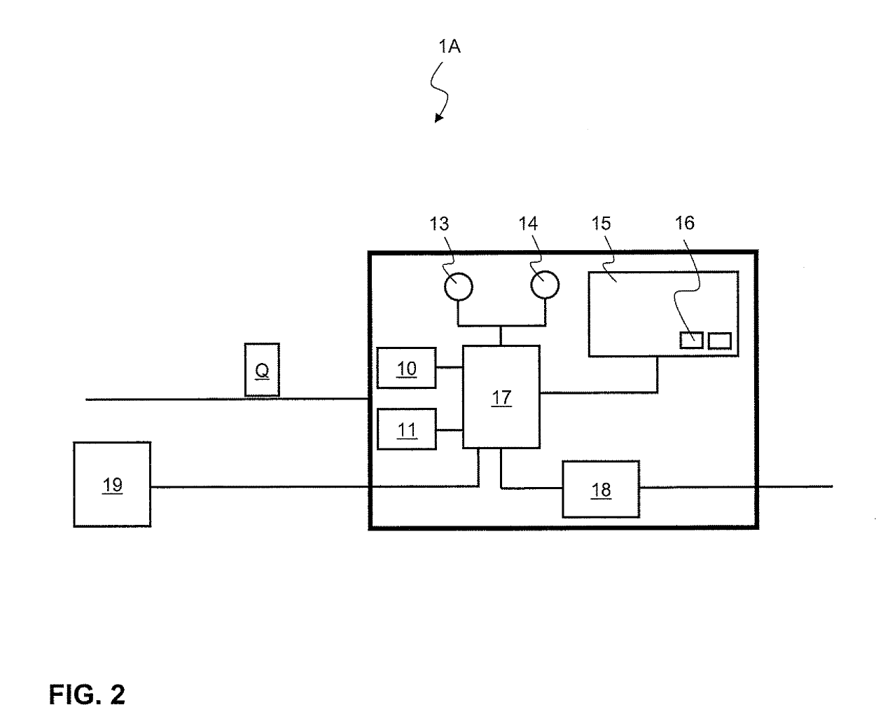

FIG. 2 provides a schematic illustration of a cash register system 1A as shown in FIG. 1. The cash register system 1A can comprise a bar code reader 10, or other input device, an age verification button 11 and an age verification system 12.

The age verification system 12 of the cash register system 1A comprises an image capture device, for example, a video camera 13 for capturing a live image of a person in front of the camera (a person image) and a document reader 14 (which also comprises an image capture device, for example, a video camera in the present embodiment) configured for reading an identification document (a document image) of that person. Identification documents include, but are not limited to, passports, identity cards, drivers licenses etc. Preferably, the identification documents comprise a picture of the owner of the identification document in combination with information of the age of the owner. However, the documents may alternatively comprise information from which the age of the owner can be derived, e.g. at the age verification center 2. The age of the owner may e.g. be derived from information already stored in the database 7 or by making a connection to an external system from which the age of the owner of the identification document can be derived.

The age verification system 10 further comprises a display 15. The display 13 can be used to inform potential purchasers that their image, and/or an image of an identification document may be required before an item can be purchased. This information may be mandatory to comply with privacy provisions in some areas. Furthermore, the display 15 may guide potential purchasers through the age verification process. The display 15 may be a touch screen comprising (soft) keys 16 for entering instructions to the age verification system 12. The keys 16 may also be buttons with dedicated functions.

It should be appreciated that the image capture devices, in this example the video camera 13 and the document reader 14, are not necessarily integral parts of the age verification system 12.

The age verification system 12 comprises a controller 17 for issuing a release signal to the cash register system 1A. To that end, the controller 17 uses one or more of the following functional modules of the age verification system 12. It should be appreciated that the functions of the modules may be largely implemented as software code portions of one or more computer programs executed by the controller 17, which may be an ordinary computer processor in combination with one or more storage devices in a manner known as such to the skilled person.

It should be appreciated however, that the controller 17 may also be configured for receiving instructions and commands from the verification center 2, in particular the controller 5. As an example, controller 5 of verification center 2 may issue a release signal to release the cash register system 1A in order to allow payment for the age-restricted item.

The age verification system 12 comprises a connection module or device 18 configured for connecting to the remote age verification center 2 to transmit the person image and/or the document image to the verification center 2. The connection module 18 may also receive commands/signals from the verification center 2, in particular an authorization signal and an identification request signal. The authorization signal may include the release signal to release the cash register system 1A to allow payment for the age-restricted item.

The controller 17 is configured for transmitting a release signal to a processor 19 of the cash register system 1A in order to release the cash register system 1A and to allow payment for the product Q, or in other words completion of sale.

In order to avoid unintended capturing of person images by video camera 13, the cash register system 1A can comprise a confirmation module (not shown, but for purposes of understanding can be considered part of controller 17) configured for instructing the video camera 13 to capture the person image.

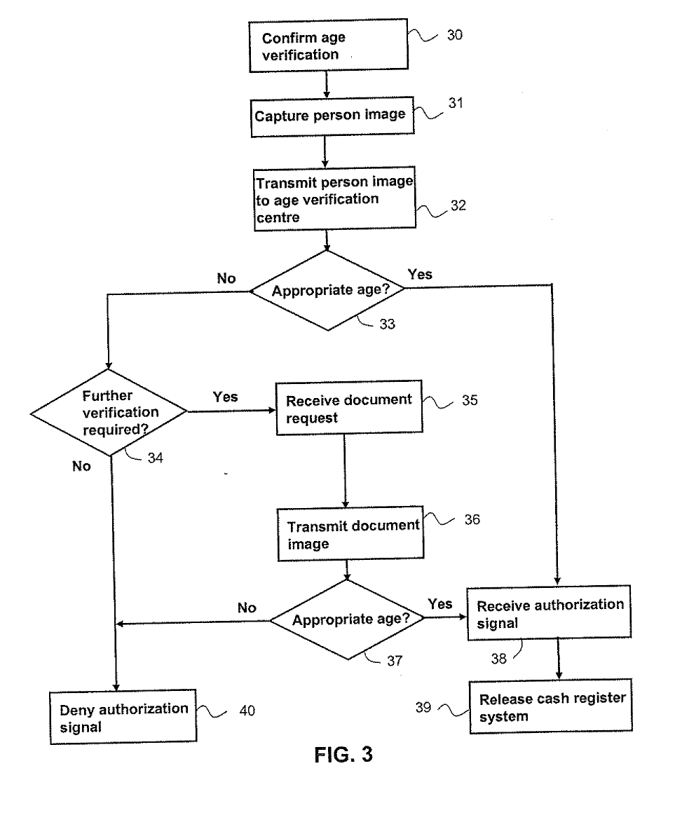

An embodiment of the operation of the system of FIG. 1 and the cash register system 1A of FIG. 2 will now be described with reference to FIG. 3. It will be assumed that a person, aged 22, enters, or desires access, to shop S and desires to perform an age-restricted task, in this example, purchase an age-restricted item Q. The age restriction for this item Q is 21. The person intends to make a payment for the age-restricted item (possibly in combination with other, non age-restricted, items). The person knowingly or unknowingly indicates an age-restricted task is desired, in this case, by scanning the age-restricted item using the bar code reader 10 of the cash register system 1A. Alternatively, the person may operate button 11 in order to start the age verification process. Another alternative includes a cashier scanning the bar code of the age-restricted item using bar code reader 10 or other input device such as a keyboard to enter the item identifier, or employs the button 11. The input device (e.g. bar code reader 10) or the button 11 may command a starting module (not shown separately but can be considered part of controller 17 for purposes of understanding) to initiate the age verification procedure.

After identifying the item Q, the display 15 may inform the person of the required age verification procedure. The person may then, in step 30, first operate the confirmation module using a key 16 in order to activate the video camera 13. The video camera 11 captures a live image of the person in step 31 and transmits the person image to the remote age verification center 2, using connection module 18 (step 32).

The controller 5 distributes the received person image to one of the available displays 6. A human operator estimates from the person image on the display 6 whether the purchaser has the required age for purchase of the selected item (step 33). If the human operator is in doubt, and believes that a further verification phase of the age is required, additional verification is provided at step 34. To that end, an identification request signal for an identification document is transmitted from the verification center 2 and received at the cash register system 1A (step 35).

The display 15, or cashier, instructs the person to provide an identification document. The document reader 14 is then activated. The person exposes an identification document to the document reader 14. An image of the identification document is transmitted from the age verification system 12 to the verification center 2 in step 36. Moreover, video camera 13 captures another image of the person and also transmits this person image to the verification center 2 in step 36. It should be noted, however, that alternatively, the person image obtained in step 32 is used again. In the latter case, the person image is e.g. retrieved from the database 7 using an entry key assigned in step 32.

The controller 5 of the verification center 2 provides the image of the document to an available display 6 (which is not necessarily the same display 6 used for the first age verification phase) in combination with the person image (received in step 36 or obtained from database 7). The human operator is now able to conclude from the identification document image and the person image that the person is the legitimate holder of the identification document and that this person has reached the age of 22 and that, consequently, he is allowed to purchase the item (step 37). An authorization signal is then transmitted from the verification center 2 and is received at the age verification system 12 in step 38. Controller 17 may now release the cash register system 1A by instructing processor 19 to allow payment by the person for the product Q (step 39).

The first age verification phase of step 33 will generally be sufficient in a majority of cases. If the person would e.g. have the age of 50, the first age verification phase would already have resulted in receiving the authorization signal in step 38. On the other hand, if the person would clearly be under-aged, the first age verification phase (step 33) would not have resulted in obtaining an authorization signal and the cashier or person would not be able to pay for the item Q, i.e. the cash register system would remain locked for this item (step 40). The same would be true if the human operator would conclude that the age of the person was not sufficient in the second age verification phase (step 37).

Although the subject matter has been described in language specific to structural features and/or methodological acts, it is to be understood that the subject matter defined in the appended claims is not necessarily limited to the specific features or acts described above as has been determined by the courts. Rather, the specific features and acts described above are disclosed as example forms of implementing the claims.

What is claimed is:

1. A cash register system comprising an age verification system configured for verifying the age of a person for purchasing an age-restricted item, the age verification system comprising:
a video camera configured configured for capturing an image of said person;
a connecting device configured for connecting to a remote age verification center and configured to transmit said image of said person to said age verification center and to receive an authorization signal from said age verification center if from said image said person can be determined to have an age allowing purchase of said age-restricted item; and
a controller configured for providing a release signal to said cash register system only in response to receiving said authorization signal to allow payment of said age-restricted item.

2. The cash register system according to claim 1, wherein said age verification system further comprises a document reader configured for capturing an image of an identification document of said person, and wherein said age verification system is further configured for:
receiving an identification request signal if said age of said person can not be determined from said image of said person, said identification request signal representing a request for providing an identification document to said document reader;
transmitting said image of said identification document to said remote age verification center, and
receiving said authorization signal from said age verification center if from said image of said identification document said person can be determined to have an age allowing purchase of said age-restricted item.

3. The cash register system according to claim 2, wherein said document reader comprises a further video camera.

4. The cash register system according to claim 1, and further comprising a starting module configured for triggering said age verification system to verify said age of said person in response to receiving item information of said age-restricted product.

5. The cash register system according to claim 1, and further comprising a starting module configured for triggering said age verification system to verify said age of said person in response to a user input.

6. A computer-implemented method of operating a cash register system for payment of an age-restricted item by a person, said cash register system comprising an age verification system, the method comprising, at said age verification system, of:
capturing an image of said person;
transmitting said image of said person to a remote age verification center;
receiving an authorization signal if from said image said person can be determined to have an age allowing purchase of said age-restricted item; and
providing a release signal to said cash register system only in response to receiving said authorization signal in order to allow payment of said age-restricted item.

7. The method according to claim 6 further comprising:
receiving an identification request signal from said remote age verification center if the age of said person can not be determined from said image of said person;
capturing an image of an identification document of said person in response to said identification request signal;
transmitting said image of said identification document to said remote age verification center; and
receiving said authorization signal if the age of the person can be determined from said image of said identification document.

8. The method according to claim 6, further comprising capturing at least one of said image of said person and said image of said document in response to receiving item information.

9. The method according to claim 6, further comprising capturing at least one of said image of said person and said image of said document in response to receiving a user input.

10. The method according to claim 6, further comprising capturing at least one of said image of said person and said image of said document with a video camera.

11. An age verification system configured for verifying the age of a person for completion of a task, the age verification system comprising:
an image capture device configured for capturing an image of said person;
a connecting device configured for connecting to a remote age verification center and configured to transmit said image of said person to said age verification center and to receive an authorization signal from said age verification center if from said image said person can be determined to have an age allowing completion of the task; and
a controller configured for providing a signal indicating that said person can complete the task based on the authorization signal.
